(19) United States
(12) Patent Application Publication
(10) Pub. No.: US 2026/0332266 A1
(43) Pub. Date: Oct. 22, 2026

(54) OPTICAL TRANSMISSION SYSTEM, OPTICAL RELAY APPARATUS, AND OPTICAL TRANSMISSION METHOD

(71) Applicant: NEC Corporation, Tokyo (JP)

(72) Inventor: Yusuke SHIMOMURA, Tokyo (JP)

(73) Assignee: NEC Corporation, Tokyo (JP)

(21) Appl. No.: 19/640,530

(22) Filed: Apr. 7, 2026

(30) Foreign Application Priority Data
Apr. 16, 2025 (JP) 2025-067283

(51) Int. Cl. H04B 10/294; H04B 10/25; H04B 10/50

(52) U.S. Cl. CPC H04B 10/2941; H04B 10/25; H04B 10/506

(57) ABSTRACT

Provided are an optical transmission system, an optical relay apparatus, and an optical transmission method capable of suppressing deterioration of transmission quality. An optical transmission system includes a first multi-core fiber, a second multi-core fiber, and an optical relay apparatus. The first multi-core fiber and the second multi-core fiber transmit the optical signal of the first wavelength group and the optical signal of the second wavelength group in different cores. The optical relay apparatus amplifies the optical signal obtained by coupling the optical signal of the first wavelength group and the optical signal of the second wavelength group transmitted through each core of the first multi-core fiber, and outputs the optical signal of the first wavelength group and the optical signal of the second wavelength group split from the optical signal amplified to each core of the second multi-core fiber.

### INCORPORATION BY REFERENCE

This application is based upon and claims the benefit of priority from Japanese patent application No. 2025-067283, filed on Apr. 16, 2025, the disclosure of which is incorporated herein in its entirety by reference.

### TECHNICAL FIELD

The present disclosure relates to an optical transmission system, an optical relay apparatus, and an optical transmission method.

### BACKGROUND ART

In recent years, in accordance with an increase in Internet traffic, it is essential to increase a transmission capacity in long-distance optical fiber transmission such as submarine optical transmission. For example, in submarine optical transmission, since the number of optical fibers that can be laid is limited, an increase in transmission capacity per optical fiber is required. Therefore, a long-distance transmission system using a multi-core fiber having a plurality of cores in one optical fiber has been studied and developed. For example, JP 2012-222613 A and JP 2014-236210 A are known as related techniques.

### SUMMARY

JP 2012-222613 A and JP 2014-236210 A disclose a method for obtaining good inter-core crosstalk characteristics. In order to increase the transmission capacity and perform long-distance transmission, it is desirable to relay an optical signal in which deterioration of transmission quality is further suppressed.

In view of such a problem, an example object of the present disclosure is to provide an optical transmission system, an optical relay apparatus, and an optical transmission method capable of suppressing deterioration of transmission quality.

An optical transmission system according to one example aspect of the present disclosure includes a first multi-core fiber that transmits, by different cores, an optical signal of a first wavelength group including a plurality of consecutive wavelengths and an optical signal of a second wavelength group including a plurality of consecutive wavelengths different from the first wavelength group, a second multi-core fiber that transmits an optical signal of the first wavelength group and an optical signal of the second wavelength group by different cores, and an optical relay apparatus that amplifies an optical signal obtained by coupling the optical signal of the first wavelength group and the optical signal of the second wavelength group transmitted through each core of the first multi-core fiber, and outputs the optical signal of the first wavelength group and the optical signal of the second wavelength group split from the optical signal amplified to each core of the second multi-core fiber.

An optical relay apparatus according to one example aspect of the present disclosure includes a first conversion unit that couples an optical signal of a first wavelength group including a plurality of consecutive wavelengths and an optical signal of a second wavelength group including a plurality of consecutive wavelengths different from the first wavelength group transmitted through different cores of a first multi-core fiber, an amplification unit that amplifies the optical signal coupled, and a second conversion unit that splits the optical signal amplified into an optical signal of the first wavelength group and an optical signal of the second wavelength group, and outputs the optical signal split of the first wavelength group and optical signal of the second wavelength group to different cores of a second multi-core fiber.

An optical transmission method according to one example aspect of the present disclosure includes transmitting, in a first multi-core fiber, an optical signal of a first wavelength group including a plurality of consecutive wavelengths and an optical signal of a second wavelength group including a plurality of consecutive wavelengths different from the first wavelength group by different cores, transmitting the optical signal of the first wavelength group and the optical signal of the second wavelength group by different cores in a second multi-core fiber, and amplifying, in an optical relay apparatus, an optical signal obtained by coupling the optical signal of the first wavelength group and the optical signal of the second wavelength group transmitted via each core of the first multi-core fiber, and outputting the optical signal of the first wavelength group and the optical signal of the second wavelength group split from the optical signal amplified to each core of the second multi-core fiber.

According to the present disclosure, deterioration of transmission quality can be suppressed.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a diagram for explaining inter-core crosstalk in a multi-core fiber;

FIG. 2 is a configuration diagram illustrating a configuration example of an optical transmission system according to some example embodiments;

FIG. 3 is a configuration diagram illustrating a configuration example of an optical relay apparatus according to some example embodiments;

FIG. 4 is a configuration diagram illustrating a configuration example of an optical transmission system according to some example embodiments;

FIG. 5 is a configuration diagram illustrating a configuration example of a multi-core fiber and a terminal station according to some example embodiments;

FIG. 6 is a diagram illustrating a band distribution of an optical signal transmitted in the optical transmission system according to some example embodiments;

FIG. 7 is a configuration diagram illustrating a configuration example of an optical repeater according to some example embodiments;

FIG. 8 is a diagram illustrating filter characteristics of a gain flattening filter according to some example embodiments;

FIG. 9 is a diagram for explaining an optical relay method according to a comparative example;

FIG. 10 is a diagram for explaining an optical relay method according to some example embodiments;

FIG. 11 is a flowchart illustrating an operation example of the optical transmission system according to some example embodiments;

FIG. 12 is a configuration diagram illustrating a configuration example of a multi-core fiber and an optical repeater according to some example embodiments;

FIG. 13 is a diagram for explaining an optical relay method according to a comparative example;

FIG. 14 is a diagram for explaining an optical relay method according to some example embodiments;

FIG. 15 is a configuration diagram illustrating a configuration example of a multi-core fiber and an optical repeater according to some example embodiments; and

FIG. 16 is a configuration diagram illustrating a configuration example of a multi-core fiber and an optical repeater according to some example embodiments.

### EXAMPLE EMBODIMENTS

Hereinafter, example embodiments will be described with reference to the drawings. In the drawings, the same elements are denoted by the same reference signs, and redundant description will be omitted as necessary.

### Study of Related Technology

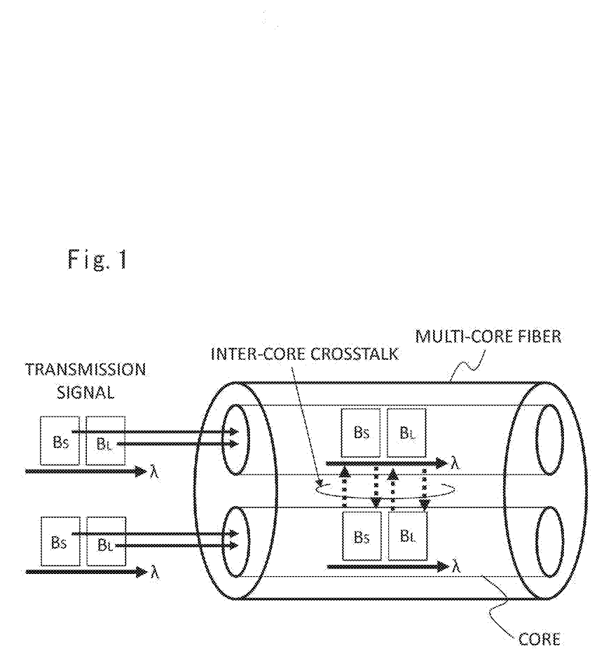

FIG. 1 is a diagram for explaining inter-core crosstalk in a multi-core fiber. As illustrated in FIG. 1, for example, in a case where an optical signal (transmission signal) including a short wavelength band B_{S} and a long wavelength band B_{L} is transmitted by using a multi-core fiber (uncoupled multi-core fiber), the optical signal including the short wavelength band B_{S} and the long wavelength band B_{L} is transmitted by two adjacent cores in the multi-core fiber. Then, since signals of the same wavelength interfere due to leakage of signals between adjacent cores, inter-core crosstalk occurs between the same wavelengths of the adjacent cores. For example, inter-core crosstalk occurs between the short wavelength bands B_{S} and between the long wavelength bands B_{L} of adjacent cores. Therefore, transmission quality is deteriorated due to inter-core crosstalk.

As a related technology, by using an optical fiber having a special structure for suppressing inter-core crosstalk, deterioration of transmission quality can be suppressed, but it is not possible to completely suppress deterioration.

### First Example Embodiment

Next, a first example embodiment will be described. In the present example embodiment, outlines of some example embodiments will be described.

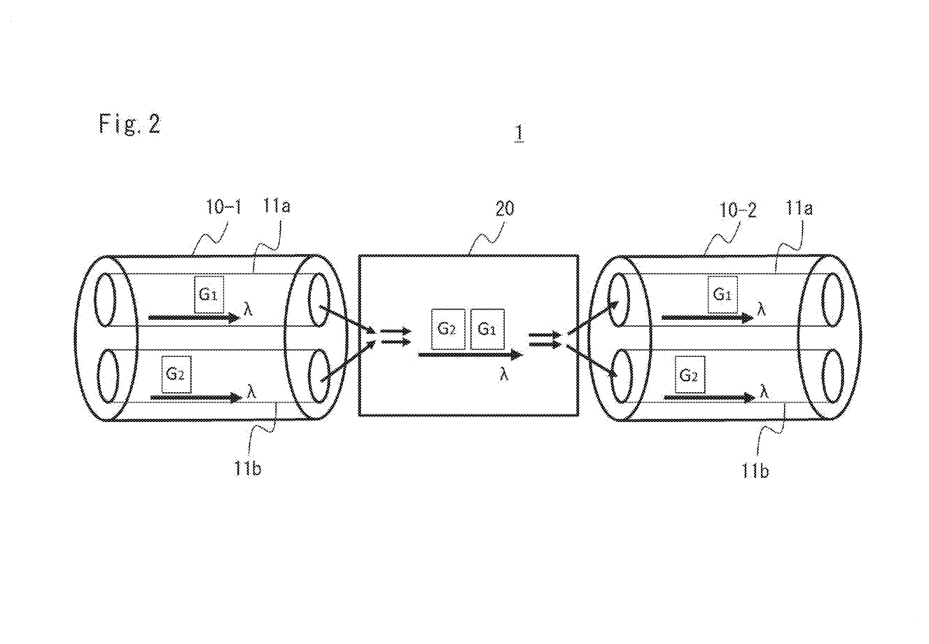

FIG. 2 illustrates a configuration example of an optical transmission system 1 according to some example embodiments. For example, the optical transmission system 1 may be a submarine optical transmission system or another optical fiber transmission system.

In the example of FIG. 2, the optical transmission system 1 includes a multi-core fiber 10 (10-1, 10-2) and an optical relay apparatus 20. The optical relay apparatus 20 relays an optical signal transmitted between the multi-core fiber 10-1 (for example, a first multi-core fiber) and the multi-core fiber 10-2 (for example, a second multi-core fiber).

The multi-core fiber 10 (10-1 and 10-2) is a transmission path for transmitting an optical signal in the optical transmission system 1. The optical signal transmitted through the transmission path may be referred to as a transmission signal. The multi-core fiber 10 includes a plurality of cores 11 capable of transmitting optical signals. For example, the multi-core fiber 10 may include two cores 11 (11a and 11b) or may include more cores. For example, the cores 11a and 11b may be cores adjacent to each other among the plurality of cores 11 in the multi-core fiber 10.

In the multi-core fiber 10, the core 11a and the core 11b transmit optical signals having different wavelengths. For example, the core 11a transmits an optical signal of a wavelength group G₁ (for example, a first wavelength group) including a plurality of consecutive wavelengths. The core 11b transmits an optical signal of a wavelength group G₂ (for example, a second wavelength group) including a plurality of consecutive wavelengths different from the wavelength group G₁. Consecutive wavelengths mean that wavelengths (wavelength channels) are adjacent to each other on the wavelength axis. The wavelength intervals of the wavelengths in the wavelength group may be equal intervals or different intervals. The transmission signal is not limited to two wavelength groups, and may be split into any number of wavelength groups. The wavelength group is also a wavelength band including a plurality of consecutive wavelengths. The number of wavelengths (bandwidths) in each wavelength group may be the same or different. For example, the wavelength group G₁ may be a long wavelength band, and the wavelength group G₂ may be a short wavelength band. The long wavelength band is a band on the long wavelength side of the entire band of the transmission signal, and the short wavelength band is a band on the short wavelength side of the entire band of the transmission signal.

In the example of FIG. 2, the core 11a (for example, a first core) of the multi-core fiber 10-1 transmits the optical signal of the first wavelength group, and outputs the transmitted optical signal to the optical relay apparatus 20. The core 11b (for example, a second core) of the multi-core fiber 10-1 transmits the optical signal of the second wavelength group, and outputs the transmitted optical signal to the optical relay apparatus 20. The core 11a (for example, a third core) of the multi-core fiber 10-2 transmits the optical signal of the first wavelength group amplified by the optical relay apparatus 20. The core 11b (for example, a fourth core) of the multi-core fiber 10-2 transmits the optical signal of the second wavelength group amplified by the optical relay apparatus 20.

The optical relay apparatus 20 couples the optical signal of the wavelength group G₁ and the optical signal of the wavelength group G₂ transmitted between the multi-core fiber 10-1 and the multi-core fiber 10-2 via different cores of the multi-core fiber 10-1, and amplifies the coupled optical signal. The optical relay apparatus 20 splits the amplified optical signal into the optical signal of the wavelength group G₁and the optical signal of the wavelength group G₂, and outputs the split optical signal of the wavelength group G₁ and the optical signal of the wavelength group G₂ to different cores of the multi-core fiber 10-2.

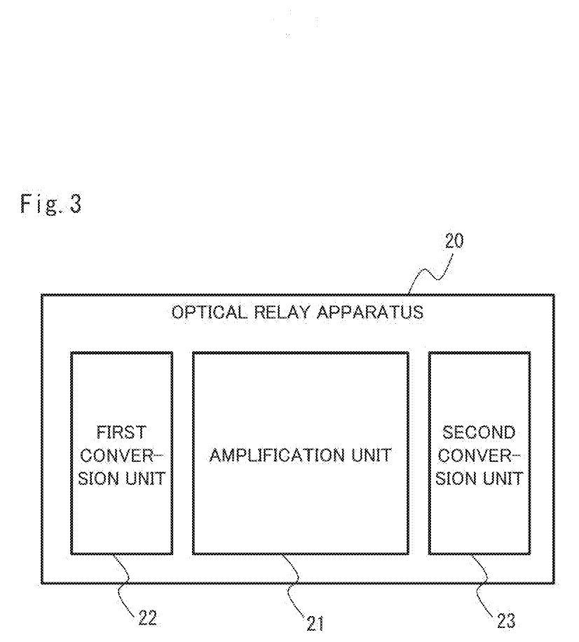

FIG. 3 illustrates a configuration example of the optical relay apparatus 20 according to some example embodiments. In the example of FIG. 3, the optical relay apparatus 20 includes an amplification unit 21, a first conversion unit 22, and a second conversion unit 23. The first conversion unit 22 (coupling unit) couples optical signals of a plurality of wavelength groups transmitted via each core 11 of the multi-core fiber 10-1, and outputs the coupled optical signals to the amplification unit 21. For example, the first conversion unit 22 couples the optical signal of the wavelength group G₁ transmitted via the core 11a of the multi-core fiber 10-1 and the optical signal of the wavelength group G₂ transmitted via the core 11b of the multi-core fiber 10-1, and outputs a coupled optical signal (for example, a first coupled optical signal). For example, the first conversion unit 22 converts an optical signal from the core 11a of the multi-core fiber 10-1 and an optical signal from the core 11b of the multi-core fiber 10-1 into an optical signal to be output to the core of the amplification unit 21.

The amplification unit 21 amplifies the optical signal coupled by the first conversion unit 22. For example, the amplification unit 21 may be an Erbium Doped Fiber Amplifier (EDFA) or another optical amplifier. The amplification unit 21 may be a multi-core EDFA or a single-core EDFA. The amplification unit 21 collectively amplifies the coupled optical signals including the wavelength group G₁ and the wavelength group G₂. For example, in the case of the single-core EDFA, the coupled optical signal including the wavelength group G₁ and the wavelength group G₂ may be amplified by one core (for example, a first amplification core).

A gain flattening filter that performs gain flattening on the coupled optical signal amplified by the amplification unit 21 may be arranged at a subsequent stage of the amplification unit 21. For example, the gain flattening filter may perform gain flattening on the optical signal of the wavelength group G₁included in the amplified coupled optical signal, and perform gain flattening on the optical signal of the wavelength group G₂ included in the amplified coupled optical signal. A first gain flattening filter that performs gain flattening on the optical signal of the wavelength group G₁ and a second gain flattening filter that performs gain flattening on the optical signal of the wavelength group G₂may be included.

The second conversion unit 23 (splitting unit) splits the coupled optical signal amplified by the amplification unit 21 into optical signals of a plurality of wavelength groups, and outputs the split optical signals of the wavelength groups to each core 11 of the multi-core fiber 10-2. For example, the second conversion unit 23 splits the coupled optical signal amplified by the amplification unit 21 into the optical signal of the wavelength group G₁and the optical signal of the wavelength group G₂, outputs the split optical signal of the wavelength group G₁to the core 11a of the multi-core fiber 10-2, and outputs the split optical signal of the wavelength group G₁ to the core 11b of the multi-core fiber 10-2. For example, the second conversion unit 23 converts the coupled optical signal from the core of the amplification unit 21 into an optical signal to be output to the core 11a of the multi-core fiber 10-2 and an optical signal to be output to the core 11b of the multi-core fiber 10-2.

As described above, in the present example embodiment, optical signals of different wavelength groups are transmitted in the cores of the multi-core fiber. In the optical relay apparatus connected between the multi-core fibers, the optical signals of the wavelength groups transmitted in the cores are coupled, and the coupled optical signals are collectively amplified. As a result, the occurrence of inter-core crosstalk in the multi-core fiber can be suppressed, and deterioration of transmission quality can be suppressed. It is possible to efficiently amplify and relay the optical signal of each wavelength group.

### Second Example Embodiment

Next, a second example embodiment will be described. In the present example embodiment, a specific example of the first example embodiment will be described.

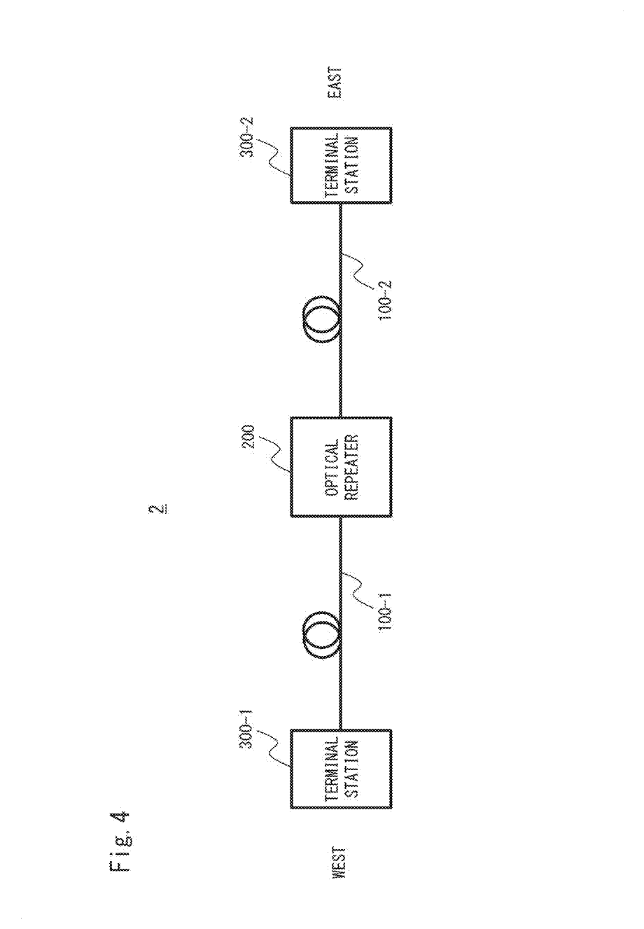

FIG. 4 illustrates a configuration example of an optical transmission system 2 according to some example embodiments. For example, the optical transmission system 2 is a submarine optical transmission system. In the example of FIG. 4, the optical transmission system 2 includes a multi-core fiber 100 (100-1 and 100-2), an optical repeater 200, and a terminal station 300 (300-1, 300-2).

For example, the terminal station 300-1 is a terminal station apparatus (optical communication apparatus) installed on the WEST side. The terminal station 300-2 is a terminal station apparatus (optical communication apparatus) installed on the EAST side. Optical transmission is performed between the terminal station 300-1 and the terminal station 300-2 via the multi-core fiber 100. For example, unidirectional transmission is performed from the terminal station 300-1 on the WEST side to the terminal station 300-2 on the EAST side. Alternatively, unidirectional transmission may be performed from the terminal station 300-2 to the terminal station 300-1. Bidirectional transmission may be performed between the terminal station 300-1 and the terminal station 300-2.

The optical repeater 200 amplifies and relays an optical signal transmitted through the multi-core fiber 100. For example, in the optical transmission system 2, a plurality of optical repeaters 200 are arranged at predetermined intervals. In the example of FIG. 4, the optical repeater 200 is disposed between the multi-core fiber 100-1 and the multi-core fiber 100-2.

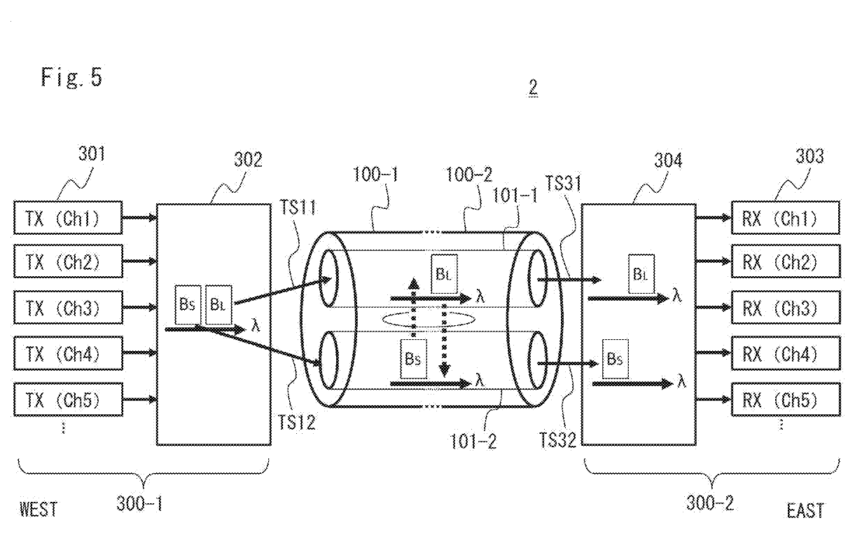

FIG. 5 illustrates a configuration example of the multi-core fiber 100 and the terminal station 300 according to some example embodiments.

In the example of FIG. 5, the multi-core fiber 100 (100-1 and 100-2) is a two-core optical fiber transmission line including a core 101-1 and a core 101-2. The core 101-1 and the core 101-2 are adjacent to each other. A transmission signal transmitted between the terminal station 300-1 and the terminal station 300-2 is split into different wavelength bands, and the split optical signals of the wavelength bands are transmitted by different cores of the multi-core fiber 100. For example, the core 101-1 transmits an optical signal of a long wavelength band B_{L} (for example, a first wavelength group), and the core 101-2 transmits an optical signal of a short wavelength band B_{S} (for example, a second wavelength group). By transmitting each wavelength band in different cores, inter-core crosstalk can be reduced.

Specifically, the core 101-1 (for example, the first core) of the multi-core fiber 100-1 (for example, the first multi-core fiber) transmits the optical signal TS11 in the long wavelength band B_{L} from the terminal station 300-1, and the core 101-2 (for example, the second core) of the multi-core fiber 100-1 transmits the optical signal TS12 in the short wavelength band B_{S} from the terminal station 300-1. Similarly, the core 101-1 (for example, the third core) of the multi-core fiber 100-2 (for example, the second multi-core fiber) transmits the optical signal TS31 in the long wavelength band B_{L} from the optical repeater 200, and the core 101-2 (for example, the fourth core) of the multi-core fiber 100-2 transmits the optical signal TS32 in the short wavelength band B_{S} from the optical repeater 200.

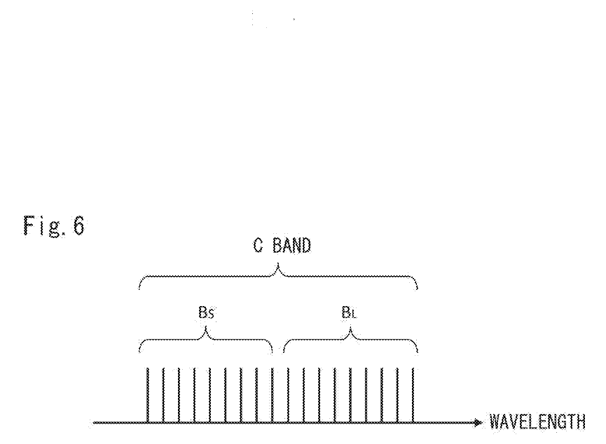

FIG. 6 illustrates an example of a wavelength band to be transmitted by each core. For example, in a case where a C band (1530 to 1565 nm) transmission signal is transmitted, the C band is split into a short wavelength band B_{S} on a short wavelength side and a long wavelength band B_{L} on a long wavelength side. For example, the short wavelength band B_{S} includes a plurality of consecutive wavelengths (wavelength channels) of 1530-1548 nm, and the long wavelength band B_{L} includes a plurality of consecutive wavelengths of 1548 to 1565 nm. The bandwidths of the short wavelength band B_{S} and the long wavelength band B_{L} may be different. For example, the wavelength intervals in each wavelength band are equal intervals, but may be different intervals. The wavelength interval in the short wavelength band B_{S} and the wavelength interval in the long wavelength band B_{L} may be different. Not only C band but also L band or other band optical signals may be transmitted. For example, the L band may be split into a short wavelength band B_{S} and a long wavelength band B_{L}. The C band may be a short wavelength band B_{S}, and the L band may be a long wavelength band B_{L}.

For example, in a case where a transmission signal is split into a predetermined bandwidth (wavelength group) like the short wavelength band B_{S} and the long wavelength band B_{L}, the transmission signal can be split and coupled with a simple configuration such as a dichroic filter. It is possible to flexibly cope with a case where the wavelength intervals are different. For example, in a case where a transmission signal is split into an odd-numbered channel and an even-numbered channel as in JP 2014-236210 A, a special configuration such as an interleaver is required, and it is not possible to cope with a case where wavelength intervals are different.

As illustrated in FIG. 5, the terminal station 300-1 on the WEST side (transmission side) includes a plurality of optical transmitters (TX) 301 and an optical splitter 302.

The plurality of optical transmitters 301 generate and output optical signals having different wavelengths (wavelength channels). For example, in a case where a C band transmission signal is transmitted, the plurality of optical transmitters 301 output an optical signal of each wavelength included in the C band.

The optical splitter 302 couples and splits the optical signals of the wavelengths generated by the plurality of optical transmitters 301. For example, the optical splitter 302 may be a Fan-in/Fan-out. The optical splitter 302 outputs the coupled and split optical signals to the cores 101-1 and 101-2 of the multi-core fiber 100-1. For example, the optical splitter 302 may couple the optical signals of the wavelengths generated by the plurality of optical transmitters 301 to generate a C band optical signal, and split the generated C band optical signal into an optical signal of the long wavelength band B_{L} and an optical signal of the short wavelength band B_{S}. For example, the optical splitter 302 outputs the optical signal TS11 in the long wavelength band B_{L} among the optical signals of the wavelengths generated by the plurality of optical transmitters 301 to the core 101-1 of the multi-core fiber 100-1, and outputs the optical signal TS12 in the short wavelength band B_{S} among the optical signals of the wavelengths generated by the plurality of optical transmitters 301 to the core 101-2 of the multi-core fiber 100-1.

The terminal station 300-2 on the EAST side (reception side) includes a plurality of optical receivers (RX) 303 and an optical splitter 304.

The plurality of optical receivers 303 are related to the plurality of optical transmitters 301, and receive optical signals of different wavelengths (wavelength channels). For example, in a case where a C band optical signal is transmitted, the plurality of optical receivers 303 receive optical signals of wavelengths included in the C band.

The optical splitter 304 splits the optical signal transmitted via the cores 101-1 and 101-2 of the multi-core fiber 100-2. For example, the optical splitter 304 may be a Fan-in/Fan-out. The optical splitter 304 outputs the split optical signals to the plurality of optical receivers 303. The optical splitter 304 splits the optical signal TS31 in the long wavelength band B_{L} transmitted via the core 101-1 of the multi-core fiber 100-2 into wavelengths, and outputs the split wavelengths to the related optical receiver 303. The optical signal TS32 of the short wavelength band B_{S} transmitted via the core 101-2 of the multi-core fiber 100-2 is split into wavelengths, and each of the split wavelengths is output to the related optical receiver 303.

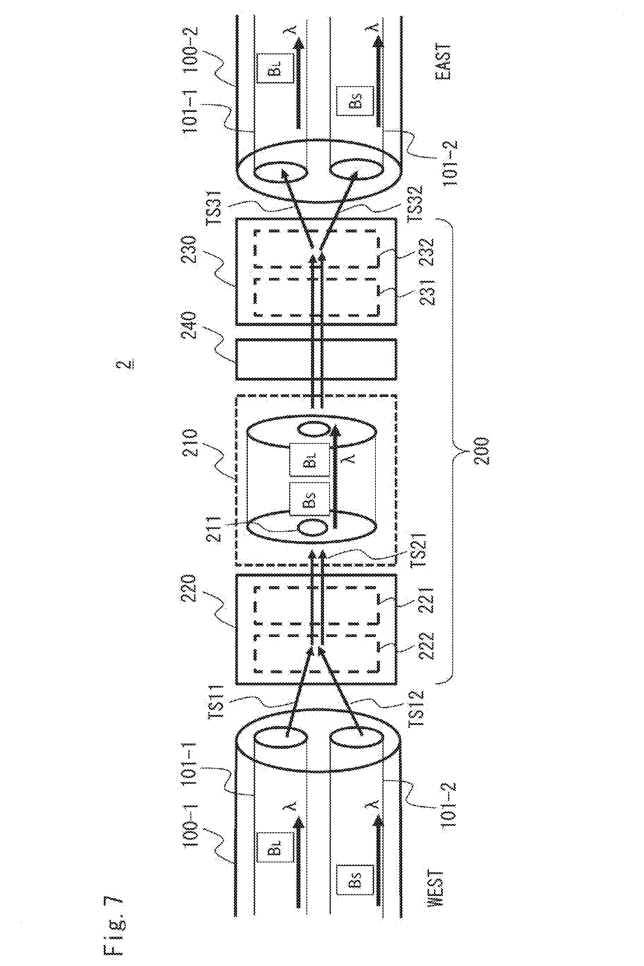

FIG. 7 illustrates a configuration example of the optical repeater 200 according to some example embodiments. In the example of FIG. 7, the optical repeater 200 includes an EDFA 210, a core conversion/wavelength coupler 220, a core conversion/wavelength splitter 230, and a gain flattening filter 240.

The core conversion/wavelength coupler 220 (for example, a first conversion unit) converts the number of cores and couples optical signals of different bands (wavelength bands) between the multi-core fiber 100-1 and the EDFA 210. For example, the core conversion/wavelength coupler 220 converts optical signals from two cores (cores 101-1 and 101-2) of the multi-core fiber 100-1 into optical signals for one core (core 211) of the EDFA 210. The core conversion/wavelength coupler 220 couples the optical signal TS11 in the long wavelength band B_{L} transmitted through the core 101-1 of the multi-core fiber 100-1 and the optical signal TS12 in the short wavelength band B_{S} transmitted through the core 101-2 of the multi-core fiber 100-1. The core conversion/wavelength coupler 220 outputs the coupled optical signal TS21 (for example, a first coupled optical signal) to the core 211 of the EDFA 210.

For example, the function of the core conversion/wavelength coupler 220 may be implemented by a Fan-in/Fan-out 222 and a dichroic filter 221. The Fan-in/Fan-out 222 and the dichroic filter 221 can couple optical signals having different bands while converting the number of cores. The Fan-in/Fan-out 222 converts the number of cores from two cores to one core. The Fan-in/Fan-out is an example of a converter that converts the number of cores of an input and an output. The dichroic filter 221 couples the optical signal in the long wavelength band B_{L} and the optical signal in the short wavelength band B_{S}. The dichroic filter is an example of a coupler that couples optical signals of different wavelength bands.

The EDFA 210 is an optical amplifier (amplification unit) that amplifies the optical signal TS21 transmitted by the multi-core fiber 100-1. The EDFA 210 receives the excitation light together with the optical signal to excite and amplify the optical signal. For example, the EDFA 210 can collectively amplify the optical signal of the entire C band. The EDFA 210 is a single-core EDFA including one core 211 (for example, a first amplification core). In the EDFA 210, the optical signal TS21 including the long wavelength band B_{L} and the short wavelength band B_{S} coupled by the core conversion/wavelength coupler 220 is input to the core 211, the optical signal TS21 is collectively amplified via the core 211, and the amplified optical signal TS21 is output.

The gain flattening filter 240 (gain equalization filter) performs gain flattening (gain equalization) on the optical signal TS21 amplified by the EDFA 210. The gain flattening filter 240 flattens the signal intensity of the optical signal TS21 including the long wavelength band B_{L} and the short wavelength band B_{S} amplified by the EDFA 210 for each wavelength band.

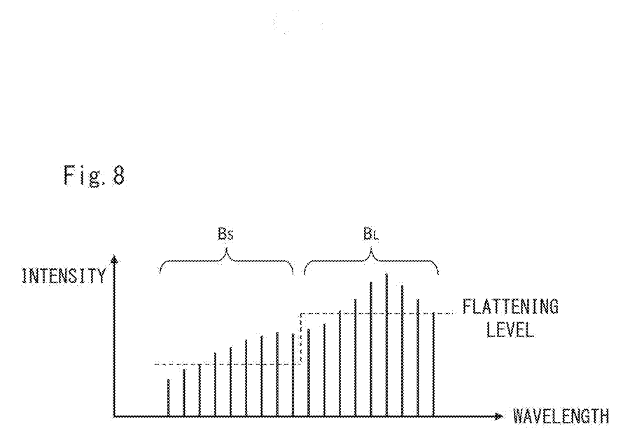

FIG. 8 illustrates filter characteristics of the gain flattening filter 240. The gain flattening filter 240 flattens the signal intensity of each wavelength in each of the long wavelength band B_{L} and the short wavelength band B_{S} of the optical signal TS21. That is, the gain flattening filter 240 flattens the signal intensity at the first flattening level for each wavelength included in the long wavelength band B_{L}, and flattens the signal intensity at the second flattening level for each wavelength included in the short wavelength band B_{S}. In the example of FIG. 8, the signal intensity of the optical signal amplified by the EDFA 210 is small in the short wavelength band and large in the long wavelength band. Therefore, the first flattening level of the long wavelength band B_{L} is larger than the second flattening level of the short wavelength band B_{S}. The gain flattening filter 240 may be set to perform flattening at different flattening levels for each band (wavelength band). The gain flattening filter 240 may include a first gain flattening filter that flattens the optical signal in the long wavelength band B_{L} at a first flattening level and a second gain flattening filter that flattens the optical signal in the short wavelength band B_{S} at a second flattening level.

Under a long-range transmission condition of a wavelength-multiplexed signal, in an EDFA generally used for amplification of a C band, a gain on a short wavelength side is lower than that on a long wavelength side. Therefore, in a case where the entire band of the C band is flattened, the flattening is performed according to the wavelength channel having the lowest gain in the entire band, and thus, the loss of the signal on the long wavelength side increases. For example, it similarly applies to a case where gains of odd-numbered channels and even-numbered channels interleaved by an interleaver are flattened as in JP 2014-236210 A. Therefore, in the present example embodiment, by performing flattening for each band, flattening is performed in accordance with the wavelength channel having the lowest gain in each band, so that the loss of the signal can be suppressed as compared with the case of flattening the entire band or the case of flattening the interleaved channel.

The core conversion/wavelength splitter 230 (for example, a second conversion unit) converts the number of cores and splits optical signals of different bands (wavelength bands) between the EDFA 210 (gain flattening filter 240) and the multi-core fiber 100-2. For example, the core conversion/wavelength splitter 230 converts an optical signal from one core (core 211) of the EDFA 210 into an optical signal for two cores (cores 101-1 and 101-2) of the multi-core fiber 100-2. The core conversion/wavelength splitter 230 splits the optical signal TS21 including the long wavelength band B_{L} and the short wavelength band B_{S} amplified via the core 211 of the EDFA 210 and gain-flattened by the gain flattening filter 240 into an optical signal TS31 of the long wavelength band B_{L} and an optical signal TS21 of the short wavelength band B_{S}. The core conversion/wavelength splitter 230 outputs the split optical signal TS31 of the long wavelength band B_{L} to the core 101-1 of the multi-core fiber 100-2, and outputs the split optical signal TS32 of the short wavelength band B_{S} to the core 101-2 of the multi-core fiber 100-2.

For example, the function of the core conversion/wavelength splitter 230 may be implemented by a dichroic filter 231 and a Fan-in/Fan-out 232. The number of cores can be converted while being split into optical signals having different bands by the dichroic filter 231 and the Fan-in/Fan-out 232. The dichroic filter 231 splits the optical signal into an optical signal in the long wavelength band B_{L} and an optical signal in the short wavelength band B_{S}. The dichroic filter is an example of a splitter that splits into optical signals of different wavelength bands. The Fan-in/Fan-out 232 converts the number of cores from one core to two cores. The Fan-in/Fan-out is an example of a converter that converts the number of cores of an input and an output.

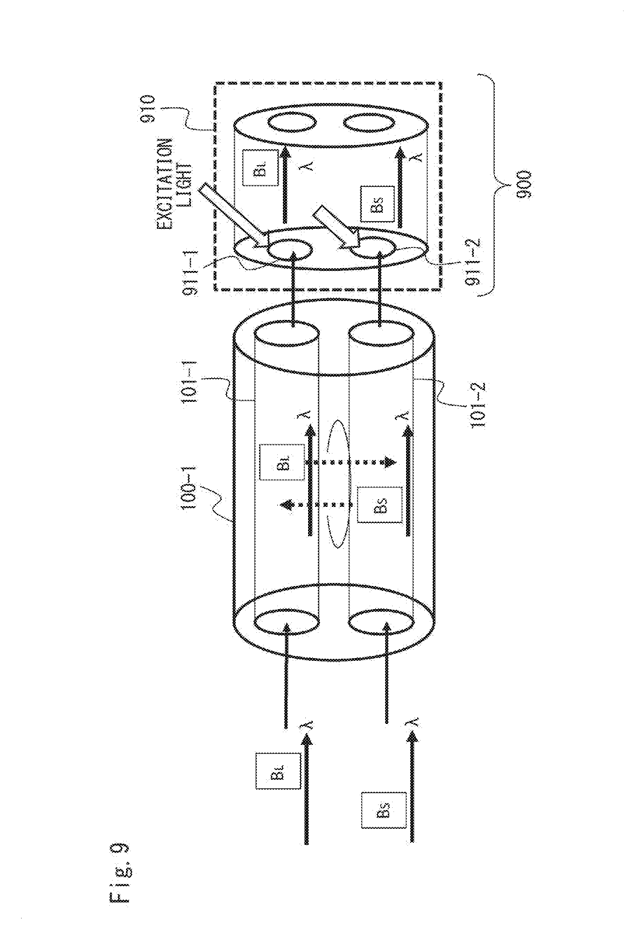

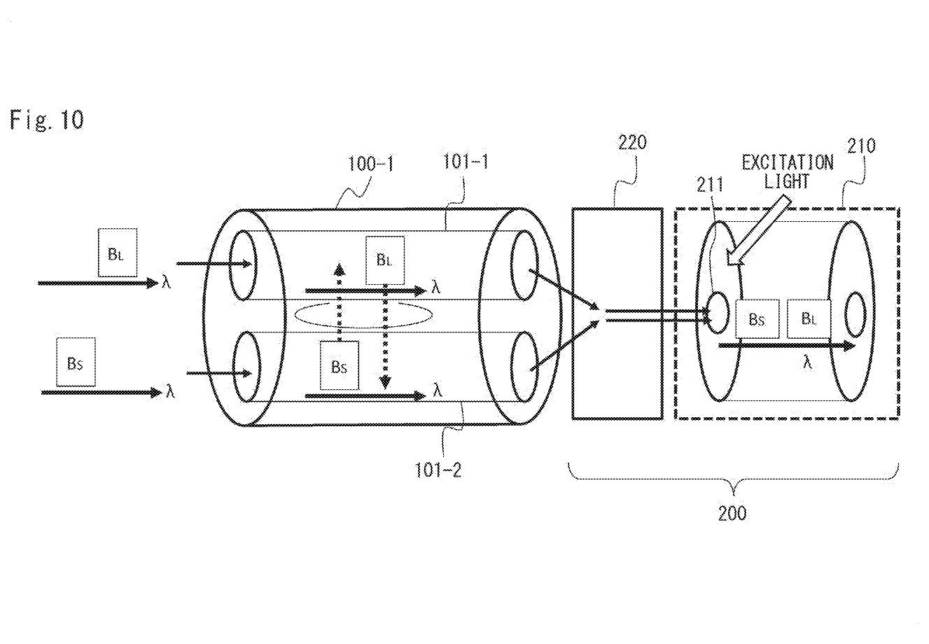

FIG. 9 is a diagram for explaining an optical relay method according to a comparative example. FIG. 10 is a diagram for explaining an optical relay method according to some example embodiments. In FIGS. 9 and 10, an optical signal in the long wavelength band B_{L} is transmitted via the core 101-1 of the multi-core fiber 100-1, and an optical signal in the short wavelength band B_{S} is transmitted via the core 101-2 of the multi-core fiber 100-1.

As illustrated in FIG. 9, the optical repeater 900 of the comparative example does not perform core conversion and wavelength coupling, and uses a two-core EDFA 910. In this case, in the EDFA 910, the core 911-1 amplifies the optical signal in the long wavelength band B_{L} transmitted via the core 101-1 of the multi-core fiber 100-1, and the core 911-2 amplifies the optical signal in the short wavelength band B_{S} transmitted via the core 101-2 of the multi-core fiber 100-1. Therefore, in the comparative example, amplifiers (EDFA) for the number of cores are required. Since excitation light is required for each core of the EDFA, power consumption increases. The EDFA can amplify a wide band like the entire C band, but if another wavelength band is amplified for each core, a wide amplification band is wasted.

On the other hand, as illustrated in FIG. 10, in the optical repeater 200 according to some example embodiments, core conversion and wavelength coupling are performed, and the single-core EDFA 210 is used. The core conversion/wavelength coupler 220 couples the optical signal of the long wavelength band B_{L} transmitted via the core 101-1 of the multi-core fiber 100-1 and the optical signal of the short wavelength band B_{S} transmitted via the core 101-2 of the multi-core fiber 100-1, and collectively amplifies the coupled optical signals including the long wavelength band B_{L} and the short wavelength band B_{S} via the core 211 of the EDFA. By providing core conversion and wavelength coupling at the input of the amplifier (EDFA), the number of amplifiers can be reduced and the power consumption can be reduced. For example, in the submarine optical transmission system, since the supply power to be supplied to the optical repeater is limited, the optical relay can be appropriately performed in a limited supply power range.

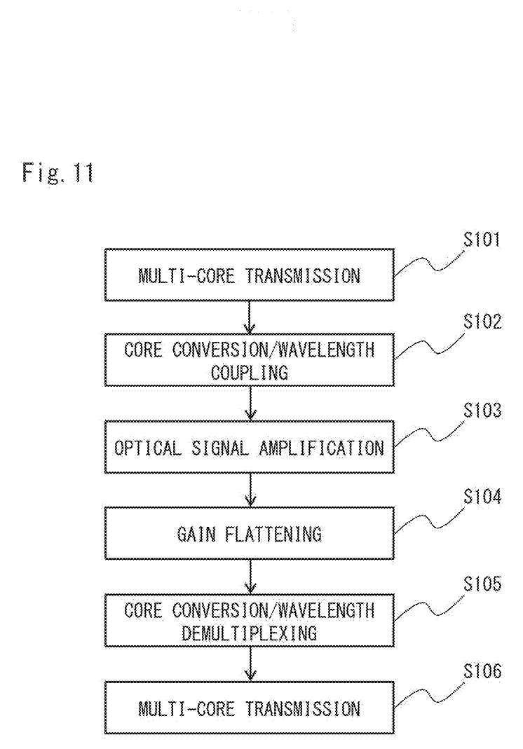

FIG. 11 illustrates an operation example of the optical transmission system 2 according to some example embodiments. In a case where an optical signal is transmitted from the terminal station 300-1 on the WEST side to the terminal station 300-2 on the EAST side, first, the optical signal is transmitted from the terminal station 300-1 via the multi-core fiber 100-1 (S101). The terminal station 300-1 couples and splits the optical signals of the wavelengths to generate the optical signal TS11 of the long wavelength band B_{L} and the optical signal TS12 of the short wavelength band B_{S}, outputs the optical signal TS11 of the long wavelength band B_{L} to the core 101-1 of the multi-core fiber 100-1, and outputs the optical signal TS12 of the short wavelength band B_{S} to the core 101-2 of the multi-core fiber 100-1. The multi-core fiber 100-1 transmits the optical signal TS11 in the long wavelength band B_{L} from the terminal station 300-1 via the core 101-1, and transmits the optical signal TS12 in the short wavelength band B_{S} from the terminal station 300-1 via the core 101-2.

Next, the core conversion/wavelength coupler 220 performs core conversion/wavelength coupling on the transmitted optical signal (S102). The core conversion/wavelength coupler 220 couples the optical signal TS11 in the long wavelength band B_{L} transmitted through the core 101-1 of the multi-core fiber 100-1 and the optical signal TS12 in the short wavelength band B_{S} transmitted through the core 101-2 of the multi-core fiber 100-1, and outputs the coupled optical signal TS21 to the core 211 of the EDFA 210.

Next, the EDFA 210 collectively amplifies the core-converted and wavelength-coupled optical signals (S103). The EDFA 210 collectively amplifies the optical signal TS21 including the long wavelength band B_{L} and the short wavelength band B_{S} coupled by the core conversion/wavelength coupler 220 via the core 211.

Next, the gain flattening filter 240 performs gain flattening on the amplified optical signal (S104). The gain flattening filter 240 flattens the signal intensity of the optical signal in the long wavelength band B_{L} of the optical signal TS21 amplified by the EDFA 210, and flattens the signal intensity of the optical signal in the short wavelength band B_{S} of the optical signal TS21 amplified by the EDFA 210.

Next, the core conversion/wavelength splitter 230 performs core conversion/wavelength demultiplexing on the amplified and gain-flattened optical signal (S105). The core conversion/wavelength splitter 230 splits the optical signal TS21 including the long wavelength band B_{L} and the short wavelength band B_{S} amplified via the core 211 of the EDFA 210 and gain-flattened by the gain flattening filter 240 into an optical signal TS31 of the long wavelength band B_{L} and an optical signal TS32 of the short wavelength band B_{S}. The core conversion/wavelength splitter 230 outputs the split optical signal TS31 of the long wavelength band B_{L} to the core 101-1 of the multi-core fiber 100-2, and outputs the split optical signal TS32 of the short wavelength band B_{S} to the core 101-2 of the multi-core fiber 100-2.

Next, an optical signal is transmitted to the terminal station 300-2 via the multi-core fiber 100-2 (S106). The multi-core fiber 100-2 transmits the optical signal TS31 in the long wavelength band B_{L} from the core conversion/wavelength splitter 230 via the core 101-1, and transmits the optical signal TS32 in the short wavelength band B_{S} from the core conversion/wavelength splitter 230 via the core 101-2. The terminal station 300-2 on the EAST side receives the optical signal TS31 in the long wavelength band B_{L} transmitted via the core 101-1 of the multi-core fiber 100-2 and the optical signal TS32 in the short wavelength band B_{S} transmitted via the core 101-2 of the multi-core fiber 100-2, splits the received optical signals, and receives the optical signals of the wavelengths.

As described above, in the present example embodiment, the transmission signal is wavelength-split into different wavelength bands, and the optical signals of the wavelength bands are transmitted by different cores. As a result, since the wavelength bands of the optical signals transmitted between the cores are different, inter-core crosstalk in the transmission path can be reduced, and deterioration of transmission quality can be suppressed.

Since the EDFA used in the optical repeated transmission has a wide amplification band, the split optical signals are coupled and amplified collectively. In a case where broadband optical amplification is performed by the EDFA, a device that converts the number of cores and performs wavelength coupling/splitting is arranged at an input/output of the EDFA. As a result, since the optical signal can be efficiently amplified, the number of EDFAs (amplifiers) can be reduced, and the power consumption can be reduced.

### First Modification of Second Example Embodiment

In the above example, the multi-core fiber (transmission path) has two cores and the EDFA has one core, but the number of cores is not limited. The multi-core fiber may include any number of cores of two or more. The EDFA may include any number of cores of one or more. For example, the number of cores of the EDFA is smaller than the number of cores of the multi-core fiber. In the first modification of the second example embodiment, the multi-core fiber has four cores and the EDFA has two cores. Also in this case, similarly to the second example embodiment, inter-core crosstalk can be reduced, and an optical signal can be efficiently amplified.

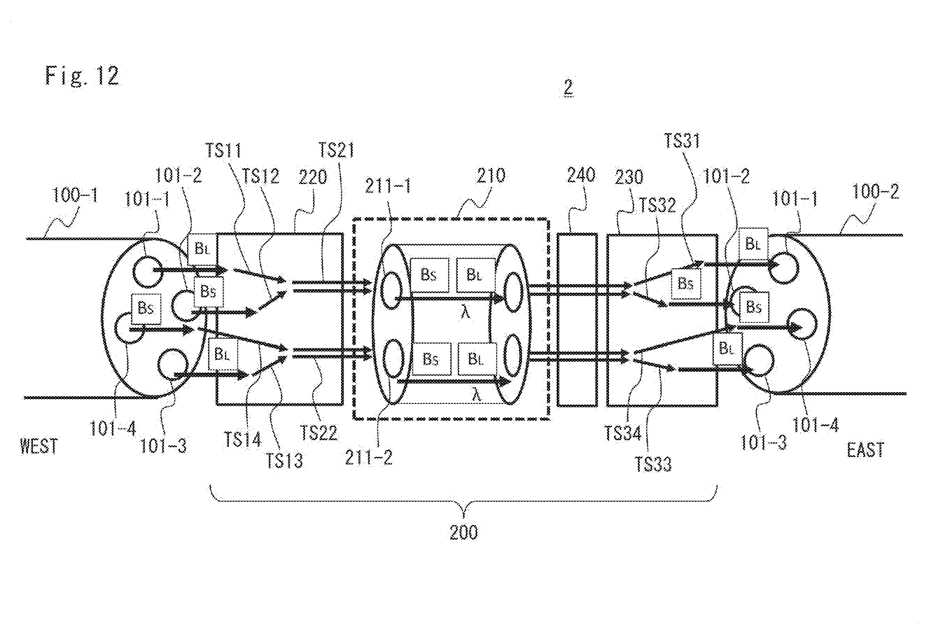

FIG. 12 illustrates a configuration example of the multi-core fiber 100 and the optical repeater 200 according to some example embodiments.

In the example of FIG. 12, the multi-core fiber 100 (100-1 and 100-2) is a four-core optical fiber transmission line including the cores 101-1 to 101-4. The core 101-1 and the core 101-2, the core 101-2 and the core 101-3, the core 101-3 and the core 101-4, and the core 101-4 and the core 101-1 are adjacent to each other (adjacent to each other). The interval between adjacent (adjacent) cores is narrower than the interval between non-adjacent cores. The interval between the core 101-1 and the core 101-2, between the core 101-2 and the core 101-3, between the core 101-3 and the core 101-4, between the core 101-4 and the core 101-1 is narrower than the interval between the core 101-1 and the core 101-3, and between the core 101-2 and the core 101-4.

Two adjacent cores transmit optical signals of different wavelength bands. Two cores that are not adjacent to each other may transmit optical signals in the same wavelength band. For example, the cores 101-1 and 101-3 transmit optical signals in the long wavelength band B_{L}, and the cores 101-2 and 101-4 transmit optical signals in the short wavelength band B_{S}. Even in this case, the inter-core crosstalk does not occur because the wavelength bands are different between the adjacent cores.

Specifically, the core 101-1 (for example, the first core) of the multi-core fiber 100-1 transmits the optical signal TS11 in the long wavelength band B_{L} from the terminal station 300-1 on the WEST side, and the core 101-2 (for example, the second core) of the multi-core fiber 100-1 transmits the optical signal TS12 in the short wavelength band B_{S} from the terminal station 300-1 on the WEST side. The core 101-3 (for example, the fifth core) of the multi-core fiber 100-1 transmits the optical signal TS13 in the long wavelength band B_{L} from the terminal station 300-1 on the WEST side, and the core 101-4 (for example, the sixth core) of the multi-core fiber 100-1 transmits the optical signal TS14 in the short wavelength band B_{S} from the terminal station 300-1 on the WEST side. Similarly, the core 101-1 (for example, the third core) of the multi-core fiber 100-2 transmits the optical signal TS31 of the long wavelength band B_{L} from the optical repeater 200, and the core 101-2 (for example, the fourth core) of the multi-core fiber 100-2 transmits the optical signal TS32 of the short wavelength band B_{S} from the optical repeater 200. The core 101-3 (for example, the seventh core) of the multi-core fiber 100-2 transmits the optical signal TS33 of the long wavelength band B_{L} from the optical repeater 200, and the core 101-4 (for example, the eighth core) of the multi-core fiber 100-2 transmits the optical signal TS34 of the short wavelength band B_{S} from the optical repeater 200.

The core conversion/wavelength coupler 220 converts optical signals from four cores (cores 101-1 to 101-4) of the multi-core fiber 100-1 into optical signals for two cores (cores 211-1 and 211-2) of the EDFA 210. The core conversion/wavelength coupler 220 couples the optical signal TS11 in the long wavelength band B_{L} transmitted through the core 101-1 of the multi-core fiber 100-1 and the optical signal TS12 in the short wavelength band B_{S} transmitted through the core 101-2 of the multi-core fiber 100-1. The core conversion/wavelength coupler 220 outputs the coupled optical signal TS21 (for example, the first coupled optical signal) to the core 211-1 of the EDFA 210. The core conversion/wavelength coupler 220 couples the optical signal TS13 in the long wavelength band B_{L} transmitted through the core 101-3 of the multi-core fiber 100-1 and the optical signal TS14 in the short wavelength band B_{S} transmitted through the core 101-4 of the multi-core fiber 100-1. The core conversion/wavelength coupler 220 outputs the coupled optical signal TS22 (for example, the second coupled optical signal) to the core 211-2 of the EDFA 210.

The EDFA 210 is a multi-core EDFA including two cores 211-1 and 211-2. For example, each of the core 211-1 and the core 211-2 can collectively amplify the optical signal of the entire C band. For example, the optical signal TS21 including the long wavelength band B_{L} and the short wavelength band B_{S} coupled by the core conversion/wavelength coupler 220 is input to the core 211-1, the optical signal TS21 is collectively amplified via the core 211-1, and the amplified optical signal TS21 is output. The optical signal TS22 including the long wavelength band B_{L} and the short wavelength band B_{S} coupled by the core conversion/wavelength coupler 220 is input to the core 211-2, and the optical signal TS22 is collectively amplified via the core 211-2.

The gain flattening filter 240 performs gain flattening on the optical signal TS21 amplified by the core 211-1 of the EDFA 210 in each of the long wavelength band B_{L} and the short wavelength band B_{S}. The gain flattening filter 240 performs gain flattening on the optical signal TS22 amplified by the core 211-2 of the EDFA 210 in each of the long wavelength band B_{L} and the short wavelength band B_{S}.

The core conversion/wavelength splitter 230 converts optical signals from two cores (cores 211-1 and 211-2) of the EDFA 210 into optical signals for four cores (cores 101-1 to 101-4) of the multi-core fiber 100-2. The core conversion/wavelength splitter 230 splits the optical signal TS21 including the long wavelength band B_{L} and the short wavelength band B_{S} amplified via the core 211-1 of the EDFA 210 and gain-flattened by the gain flattening filter 240 into an optical signal TS31 of the long wavelength band B_{L} and an optical signal TS32 of the short wavelength band B_{S}. The core conversion/wavelength splitter 230 outputs the split optical signal TS31 of the long wavelength band B_{L} to the core 101-1 of the multi-core fiber 100-2, and outputs the split optical signal TS32 of the short wavelength band B_{S} to the core 101-2 of the multi-core fiber 100-2. The core conversion/wavelength splitter 230 splits the optical signal TS22 including the long wavelength band B_{L} and the short wavelength band B_{S} amplified via the core 211-2 of the EDFA 210 and gain-flattened by the gain flattening filter 240 into an optical signal TS33 of the long wavelength band B_{L} and an optical signal TS34 of the short wavelength band B_{S}. The core conversion/wavelength splitter 230 outputs the split optical signal TS33 of the long wavelength band B_{L} to the core 101-3 of the multi-core fiber 100-2, and outputs the split optical signal TS34 of the short wavelength band B_{S} to the core 101-4 of the multi-core fiber 100-2.

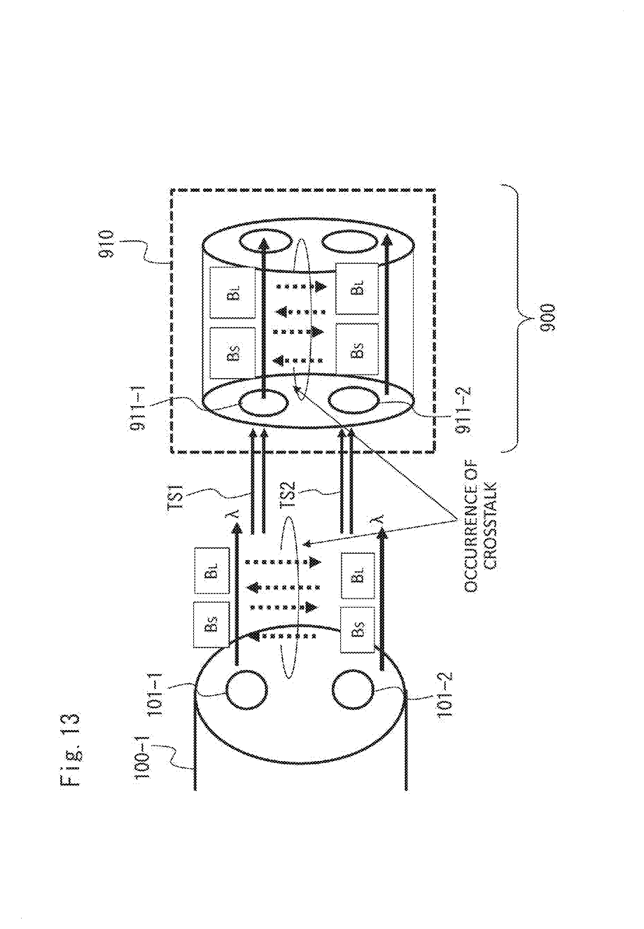

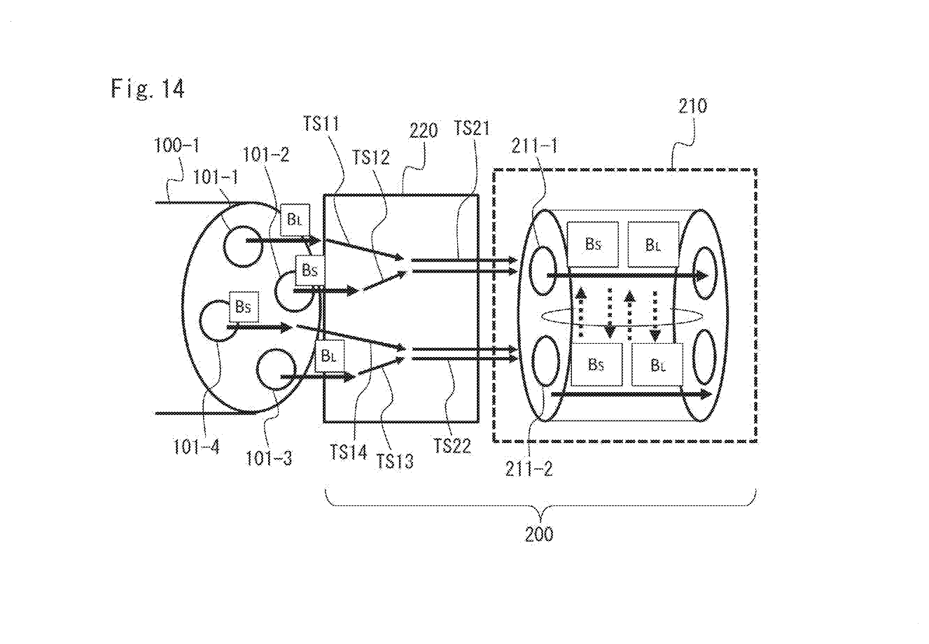

FIG. 13 is a diagram for explaining an optical relay method according to a comparative example. FIG. 14 is a diagram for explaining an optical relay method according to some example embodiments.

As illustrated in FIG. 13, in the comparative example, a multi-core fiber having two cores and an EDFA 910 having two cores are used. That is, the optical signal TS1 including the long wavelength band B_{L} and the short wavelength band B_{S} is transmitted via the core 101-1 of the multi-core fiber 100-1, and the optical signal TS2 including the long wavelength band B_{L} and the short wavelength band B_{S} is transmitted via the core 101-2 of the multi-core fiber 100-1. The core 911-1 of the EDFA 910 amplifies the optical signal TS1 including the long wavelength band B_{L} and the short wavelength band B_{S} transmitted via the core 101-1 of the multi-core fiber 100-1, and the core 911-2 of the EDFA 910 amplifies the optical signal TS2 including the long wavelength band B_{L} and the short wavelength band B_{S} transmitted via the core 101-2 of the multi-core fiber 100-1. Therefore, in the example of FIG. 13, inter-core crosstalk occurs in both the multi-core fiber (transmission path) and the amplifier (EDFA).

On the other hand, as illustrated in FIG. 14, in some example embodiments, a four-core multi-core fiber and a two-core EDFA 210 are used. That is, as described above, the optical signal TS11 in the long wavelength band B_{L} is transmitted via the core 101-1 of the multi-core fiber 100-1, and the optical signal TS12 in the short wavelength band B_{S} is transmitted via the core 101-2 of the multi-core fiber 100-1. The optical signal TS13 in the long wavelength band B_{L} is transmitted through the core 101-3 of the multi-core fiber 100-1, and the optical signal TS14 in the short wavelength band B_{S} is transmitted through the core 101-4 of the multi-core fiber 100-1. The core conversion/wavelength coupler 220 couples the optical signal of the long wavelength band B_{L} transmitted via the core 101-1 of the multi-core fiber 100-1 and the optical signal of the short wavelength band B_{S} transmitted via the core 101-2 of the multi-core fiber 100-1 to the optical signal TS21, and couples the optical signal of the long wavelength band B_{L} transmitted via the core 101-3 of the multi-core fiber 100-1 and the optical signal of the short wavelength band B_{S} transmitted via the core 101-4 of the multi-core fiber 100-1 to the optical signal TS22. Further, the core 211-1 of the EDFA 210 amplifies the optical signal TS21 including the long wavelength band B_{L} and the short wavelength band B_{S} that have been coupled by the core conversion/wavelength coupler 220, and the core 211-2 of the EDFA 210 amplifies the optical signal TS22 including the long wavelength band B_{L} and the short wavelength band B_{S} that have been coupled by the core conversion/wavelength coupler 220.

Therefore, in the example of FIG. 14, inter-core crosstalk does not occur in the multi-core fiber (transmission path). For example, by using a two-core EDFA used in an optical transmission system of a two-core multi-core fiber as it is and using a multi-core fiber (transmission path), inter-core crosstalk can be further reduced. Since the length of the fiber of the EDFA (for example, several tens of meters) is much shorter than the length of the fiber of the transmission line (for example, several tens of kilometers), the influence of inter-core crosstalk due to the EDFA is small in the entire system.

### Second Modification of Second Example Embodiment

In the above example, transmission is performed only in one direction from the WEST side to the EAST side, but the transmission direction may be different for each core. In the second modification of the second example embodiment, bidirectional transmission is performed in a configuration similar to the first modification of the second example embodiment. Also in this case, similarly to the second example embodiment, inter-core crosstalk can be reduced, and an optical signal can be efficiently amplified.

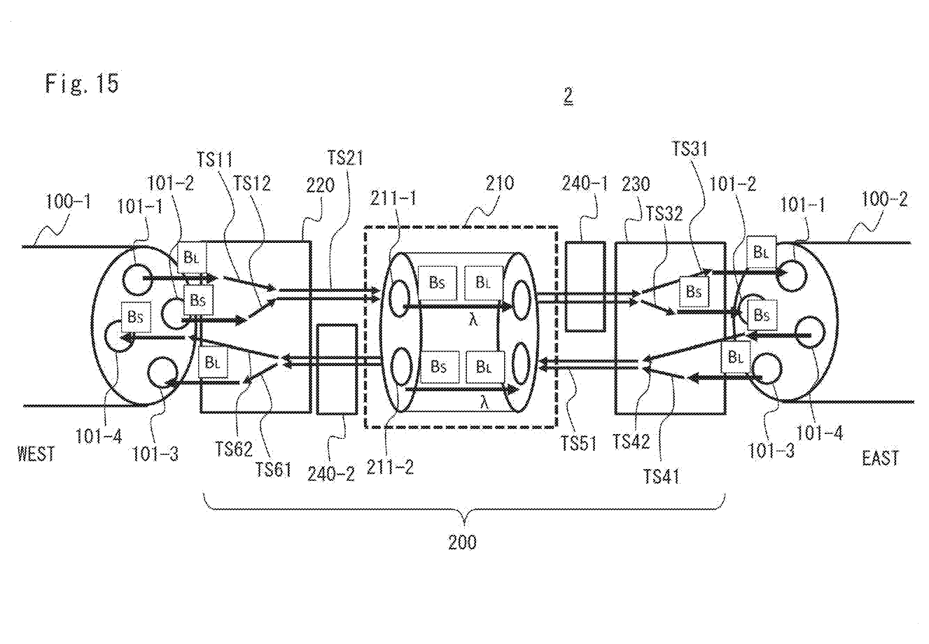

FIG. 15 illustrates a configuration example of the multi-core fiber 100 and the optical repeater 200 according to some example embodiments. In the example of FIG. 15, gain flattening filters 240-1 and 240-2 are provided as compared with the configuration of FIG. 12. The rest is similar to those in FIG. 12.

In the example of FIG. 15, transmission and relay of the optical signal from the WEST side to the EAST side are similar to those in FIG. 12. That is, the core 101-1 (for example, the first core) of the multi-core fiber 100-1 transmits the optical signal TS11 in the long wavelength band B_{L} from the WEST side. The core 101-2 (for example, the second core) of the multi-core fiber 100-1 transmits the optical signal TS12 in the short wavelength band B_{S} from the WEST side. The core 211-1 of the EDFA 210 collectively amplifies the optical signal TS21 (for example, the first coupled optical signal) including the long wavelength band B_{L} and the short wavelength band B_{S} coupled by the core conversion/wavelength coupler 220. The core 101-1 (for example, the third core) of the multi-core fiber 100-2 transmits the optical signal TS31 of the long wavelength band B_{L} split by the core conversion/wavelength splitter 230 to the EAST side via the gain flattening filter 240-1. The core 101-2 (for example, the fourth core) of the multi-core fiber 100-2 transmits the optical signal TS32 of the short wavelength band B_{S} split by the core conversion/wavelength splitter 230 to the EAST side via the gain flattening filter 240-1.

Transmission and relay of the optical signal from the EAST side to the WEST side are opposite to those in FIG. 12. That is, the core 101-3 (for example, the seventh core) of the multi-core fiber 100-2 transmits the optical signal TS41 in the long wavelength band B_{L} from the EAST side. The core 101-4 (for example, the eighth core) of the multi-core fiber 100-2 transmits the optical signal TS42 in the short wavelength band B_{S} from the EAST side. The core 211-2 of the EDFA 210 collectively amplifies the optical signal TS51 (for example, the third coupled optical signal) including the long wavelength band B_{L} and the short wavelength band B_{S} coupled by the core conversion/wavelength splitter 230 (in this case, the core conversion/wavelength coupler). The core 101-3 (for example, the fifth core) of the multi-core fiber 100-1 transmits the optical signal TS61 in the long wavelength band B_{L} split by the core conversion/wavelength coupler 220 (in this case, the core conversion/wavelength splitter) to the WEST side via the gain flattening filter 240-2. The core 101-4 (for example, the sixth core) of the multi-core fiber 100-1 transmits the optical signal TS62 of the short wavelength band B_{S} split by the core conversion/wavelength coupler 220 to the WEST side via the gain flattening filter 240-2.

### Third Modification of Second Example Embodiment

In the above example, the transmission signal is split into two wavelength bands, but may be split into any number of two or more wavelength bands. In the third modification of the second example embodiment, the transmission signal is split into four wavelength bands. Also in this case, similarly to the second example embodiment, inter-core crosstalk can be reduced, and an optical signal can be efficiently amplified.

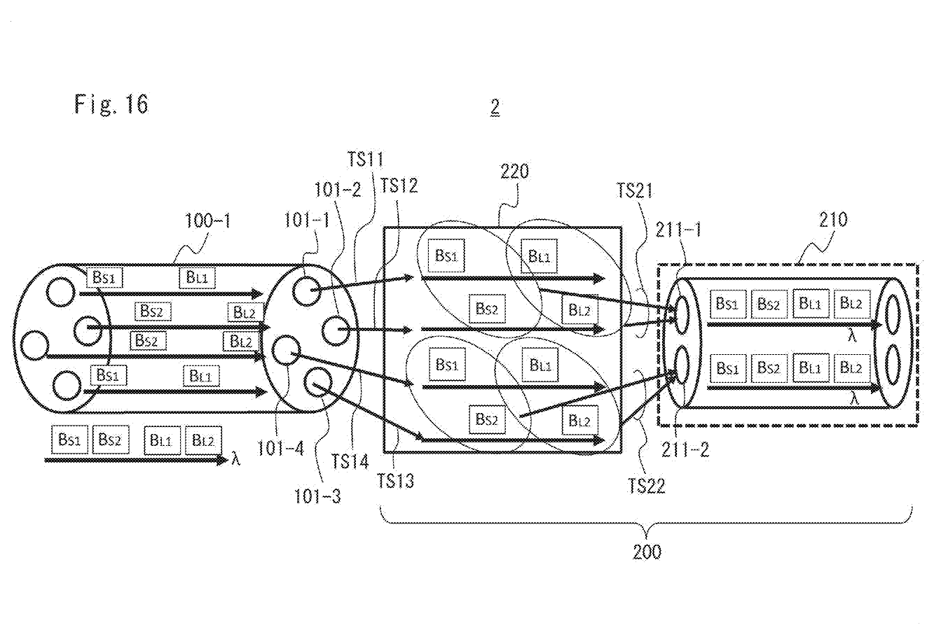

FIG. 16 illustrates a configuration example of the multi-core fiber 100 and the optical repeater 200 according to some example embodiments. In the example of FIG. 16, the configuration is similar to that of FIG. 12, but only the multi-core fiber 100-1, the core conversion/wavelength coupler 220, and the EDFA 210 are illustrated for simplification. The configuration of FIG. 16 may be applied to the configurations of FIGS. 7 and 15.

In the example of FIG. 16, an optical signal to be transmitted is split into a short wavelength band B_{S1} (for example, a first wavelength group), a short wavelength band B_{S2} (for example, a second wavelength group), a long wavelength band B_{L1} (for example, a third wavelength group), and a long wavelength band B_{L2} (for example, a fourth wavelength group). For example, each wavelength band has a relationship of short wavelength band B_{S1} < short wavelength band B_{S2} < long wavelength band B_{L1} < long wavelength band B_{L2}.

For example, the core 101-1 of the multi-core fiber 100-1 transmits the optical signal TS11 including the long wavelength band B_{L1} and the short wavelength band B_{S1} from the WEST side. The core 101-2 of the multi-core fiber 100-1 transmits the optical signal TS12 including the long wavelength band B_{L2} and the short wavelength band B_{S2} from the WEST side. The core 101-3 of the multi-core fiber 100-1 transmits the optical signal TS13 including the long wavelength band B_{L1} and the short wavelength band B_{S1} from the WEST side. The core 101-4 of the multi-core fiber 100-1 transmits the optical signal TS14 including the long wavelength band B_{L2} and the short wavelength band B_{S2} from the WEST side. It similarly applies to the multi-core fiber 100-2. Even in this case, the inter-core crosstalk does not occur because the wavelength bands are different between the adjacent cores. The optical signals of the short wavelength band B_{S1}, the short wavelength band B_{S2}, the long wavelength band B_{L1}, and the long wavelength band B_{L2} may be transmitted by different cores.

The core conversion/wavelength coupler 220 (core conversion/wavelength demultiplexing coupler) couples the optical signals of the short wavelength band B_{S1}, the short wavelength band B_{S2}, the long wavelength band B_{L1}, and the long wavelength band B_{L2} transmitted via the multi-core fiber 100-1. The core conversion/wavelength coupler 220 couples the optical signal TS11 including the long wavelength band B_{L1} and the short wavelength band B_{S1} transmitted via the core 101-1 of the multi-core fiber 100-1 and the optical signal TS12 including the long wavelength band B_{L2} and the short wavelength band B_{S2} transmitted via the core 101-2 of the multi-core fiber 100-1, and outputs the coupled optical signal TS21 to the core 211-1 of the EDFA 210. The core conversion/wavelength coupler 220 couples the optical signal TS13 including the long wavelength band B_{L1} and the short wavelength band B_{S1} transmitted via the core 101-3 of the multi-core fiber 100-1 and the optical signal TS14 including the long wavelength band B_{L2} and the short wavelength band B_{S2} transmitted via the core 101-4 of the multi-core fiber 100-1, and outputs the coupled optical signal TS22 to the core 211-2 of the EDFA 210.

The core 211-1 of the EDFA 210 collectively amplifies the optical signal TS21 including the short wavelength band B_{S1}, the short wavelength band B_{S2}, the long wavelength band B_{L1}, and the long wavelength band B_{L2} coupled by the core conversion/wavelength coupler 220. The core 211-2 of the EDFA 210 collectively amplifies the optical signal TS22 including the short wavelength band B_{S1}, the short wavelength band B_{S2}, the long wavelength band B_{L1}, and the long wavelength band B_{L2} coupled by the core conversion/wavelength coupler 220.

Although not illustrated, in this case, the gain flattening filter 240 performs gain flattening on the optical signals TS21 and TS22 amplified by the cores 211-1 and 211-2 of the EDFA 210 in each of the short wavelength band B_{S1}, the short wavelength band B_{S2}, the long wavelength band B_{L1}, and the long wavelength band B_{L2}. The core conversion/wavelength splitter 230 splits the amplified and gain-flattened optical signal TS21 into a short wavelength band B_{S1}, a short wavelength band B_{S2}, a long wavelength band B_{L1}, and a long wavelength band B_{L2}, outputs an optical signal including the long wavelength band B_{L1} and the short wavelength band B_{S1} to the core 101-1 of the multi-core fiber 100-2, and outputs an optical signal including the long wavelength band B_{L2} and the short wavelength band B_{S2} to the core 101-2 of the multi-core fiber 100-2. The core conversion/wavelength splitter 230 splits the amplified and gain-flattened optical signal TS22 into a short wavelength band B_{S1}, a short wavelength band B_{S2}, a long wavelength band B_{L1}, and a long wavelength band B_{L2}, outputs an optical signal including the long wavelength band B_{L1} and the short wavelength band B_{S1} to the core 101-3 of the multi-core fiber 100-2, and outputs an optical signal including the long wavelength band B_{L2} and the short wavelength band B_{S2} to the core 101-4 of the multi-core fiber 100-2.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Each of the drawings is merely illustrative for describing one or more example embodiments. Each of the drawings is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated or described. All of the features or steps illustrated in any one of the drawings to describe illustrative example embodiments are not necessarily mandatory, and some features or steps may be omitted. The order of the steps described in any of the drawings may be changed as appropriate.

Some or all of the example embodiments described above may also be described as, but are not limited to, the following Supplementary Notes.

### Supplementary Note 1

An optical transmission system including:
a first multi-core fiber that transmits, by different cores, an optical signal of a first wavelength group including a plurality of consecutive wavelengths and an optical signal of a second wavelength group including a plurality of consecutive wavelengths different from the first wavelength group;
a second multi-core fiber that transmits an optical signal of the first wavelength group and an optical signal of the second wavelength group by different cores; and
an optical relay apparatus that amplifies an optical signal obtained by coupling the optical signal of the first wavelength group and the optical signal of the second wavelength group transmitted through each core of the first multi-core fiber, and outputs the optical signal of the first wavelength group and the optical signal of the second wavelength group split from the optical signal amplified to each core of the second multi-core fiber.

### Supplementary Note 2

The optical transmission system according to Supplementary Note 1, wherein wavelength intervals of wavelengths in the first wavelength group and the second wavelength group are equal.

### Supplementary Note 3

The optical transmission system according to Supplementary Note 1, wherein wavelength intervals of wavelengths in the first wavelength group and the second wavelength group are different.

### Supplementary Note 4

The optical transmission system according to Supplementary Note 1, wherein

in the first multi-core fiber, a core that transmits an optical signal of the first wavelength group and a core that transmits an optical signal of the second wavelength group are cores adjacent to each other, and

in the second multi-core fiber, a core that transmits an optical signal of the first wavelength group and a core that transmits an optical signal of the second wavelength group are cores adjacent to each other.

### Supplementary Note 5

The optical transmission system according to Supplementary Note 1, wherein
the first multi-core fiber includes a first core that transmits an optical signal of the first wavelength group and a second core that transmits an optical signal of the second wavelength group,
the second multi-core fiber includes a third core that transmits an optical signal of the first wavelength group and a fourth core that transmits an optical signal of the second wavelength group, and
the optical relay apparatus includes:
a first conversion unit that couples the optical signal of the first wavelength group transmitted through the first core and the optical signal of the second wavelength group transmitted through the second core to generate a first coupled optical signal;
an amplification unit that amplifies the first coupled optical signal generated; and
a second conversion unit that splits the first coupled optical signal amplified into an optical signal of the first wavelength group and an optical signal of the second wavelength group, outputs the optical signal split of the first wavelength group to the third core, and outputs the optical signal split of the second wavelength group to the fourth core.

### Supplementary Note 6

The optical transmission system according to Supplementary Note 5, wherein the optical relay apparatus includes a gain flattening filter that performs gain flattening on the first coupled optical signal amplified.

### Supplementary Note 7

The optical transmission system according to Supplementary Note 6, wherein the gain flattening filter performs gain flattening on the optical signal of the first wavelength group included in the first coupled optical signal amplified and performs gain flattening on the optical signal of the second wavelength group included in the first coupled optical signal amplified.

### Supplementary Note 8

The optical transmission system according to Supplementary Note 6, wherein the gain flattening filter includes a first gain flattening filter that performs gain flattening on the optical signal of the first wavelength group included in the first coupled optical signal amplified, and a second gain flattening filter that performs gain flattening on the optical signal of the second wavelength group included in the first coupled optical signal amplified.

### Supplementary Note 9

The optical transmission system according to Supplementary Note 5, wherein

the amplification unit includes a first amplification core that amplifies the coupled first coupled optical signal,

the first conversion unit converts an optical signal of the first wavelength group from the first core and an optical signal of the second wavelength group from the second core into the first coupled optical signal to be output to the first amplification core, and

the second conversion unit converts the first coupled optical signal from the first amplification core into an optical signal of the first wavelength group to be output to the third core and an optical signal of the second wavelength group to be output to the fourth core.

### Supplementary Note 10

The optical transmission system according to Supplementary Note 5, wherein

the first multi-core fiber includes a fifth core that transmits the optical signal of the first wavelength group and a sixth core that transmits the optical signal of the second wavelength group,

the second multi-core fiber includes a seventh core that transmits the optical signal of the first wavelength group and an eighth core that transmits the optical signal of the second wavelength group,

the first conversion unit couples the optical signal of the first wavelength group transmitted through the fifth core and the optical signal of the second wavelength group transmitted through the sixth core to generate a second coupled optical signal,

the amplification unit amplifies the second coupled optical signal generated, and

the second conversion unit splits the second coupled optical signal amplified into an optical signal of the first wavelength group and an optical signal of the second wavelength group, outputs the optical signal split of the first wavelength group to the seventh core, and outputs the optical signal split of the second wavelength group to the eighth core.

### Supplementary Note 11

The optical transmission system according to Supplementary Note 5, wherein

the first multi-core fiber includes a fifth core that transmits the optical signal of the first wavelength group and a sixth core that transmits the optical signal of the second wavelength group,

the second multi-core fiber includes a seventh core that transmits the optical signal of the first wavelength group and an eighth core that transmits the optical signal of the second wavelength group,

the second conversion unit couples the optical signal of the first wavelength group transmitted through the seventh core and the optical signal of the second wavelength group transmitted through the eighth core to generate a third coupled optical signal,

the amplification unit amplifies the third coupled optical signal generated, and

the first conversion unit splits the third coupled optical signal amplified into an optical signal of the first wavelength group and an optical signal of the second wavelength group, outputs the optical signal split of the first wavelength group to the fifth core, and outputs the optical signal split of the second wavelength group to the sixth core.

### Supplementary Note 12

The optical transmission system according to Supplementary Note 1, wherein

the first multi-core fiber transmits an optical signal of a third wavelength group including a plurality of consecutive wavelengths different from the first and second wavelength groups and an optical signal of a fourth wavelength group including a plurality of consecutive wavelengths different from the first to third wavelength groups by further different cores,

the second multi-core fiber transmits the optical signal of the third wavelength group and the optical signal of the fourth wavelength group by further different cores, and

the optical relay apparatus amplifies an optical signal obtained by coupling the optical signal of the third wavelength group and the optical signal of the fourth wavelength group transmitted via each core of the first multi-core fiber, and outputs the optical signal of the third wavelength group and the optical signal of the fourth wavelength group split from the optical signal amplified to each core of the second multi-core fiber.

### Supplementary Note 13

An optical relay apparatus including:
a first conversion unit that couples an optical signal of a first wavelength group including a plurality of consecutive wavelengths and an optical signal of a second wavelength group including a plurality of consecutive wavelengths different from the first wavelength group transmitted through different cores of a first multi-core fiber;
an amplification unit that amplifies the optical signal coupled; and
a second conversion unit that splits the optical signal amplified into an optical signal of the first wavelength group and an optical signal of the second wavelength group, and outputs the optical signal split of the first wavelength group and optical signal of the second wavelength group to different cores of a second multi-core fiber.

### Supplementary Note 14

An optical transmission method including:
transmitting, in a first multi-core fiber, an optical signal of a first wavelength group including a plurality of consecutive wavelengths and an optical signal of a second wavelength group including a plurality of consecutive wavelengths different from the first wavelength group by different cores;
transmitting the optical signal of the first wavelength group and the optical signal of the second wavelength group by different cores in a second multi-core fiber; and
amplifying, in an optical relay apparatus, an optical signal obtained by coupling the optical signal of the first wavelength group and the optical signal of the second wavelength group transmitted via each core of the first multi-core fiber, and outputting the optical signal of the first wavelength group and the optical signal of the second wavelength group split from the optical signal amplified to each core of the second multi-core fiber.

Some or all of the elements (for example, configurations and functions) described in Supplementary Notes 2 to 12 dependent on Supplementary Note 1 (optical transmission system) can also be dependent on Supplementary Note 13 (optical relay apparatus) and Supplementary Note 14 (optical transmission method) by a dependency relationship similar to Supplementary Notes 2 to 12. Some or all of the elements described in any Supplementary Notes may be applied to various hardware, software, recording means for recording software, systems, and methods.

What is claimed is:

1. An optical transmission system comprising:
a first multi-core fiber that transmits, by different cores, an optical signal of a first wavelength group including a plurality of consecutive wavelengths and an optical signal of a second wavelength group including a plurality of consecutive wavelengths different from the first wavelength group;
a second multi-core fiber that transmits an optical signal of the first wavelength group and an optical signal of the second wavelength group by different cores; and
an optical relay apparatus that amplifies an optical signal obtained by coupling the optical signal of the first wavelength group and the optical signal of the second wavelength group transmitted through each core of the first multi-core fiber, and outputs the optical signal of the first wavelength group and the optical signal of the second wavelength group split from the optical signal amplified to each core of the second multi-core fiber.

2. The optical transmission system according to claim 1, wherein wavelength intervals of wavelengths in the first wavelength group and the second wavelength group are equal.

3. The optical transmission system according to claim 1, wherein wavelength intervals of wavelengths in the first wavelength group and the second wavelength group are different.

4. The optical transmission system according to claim 1, wherein
in the first multi-core fiber, a core that transmits an optical signal of the first wavelength group and a core that transmits an optical signal of the second wavelength group are cores adjacent to each other, and
in the second multi-core fiber, a core that transmits an optical signal of the first wavelength group and a core that transmits an optical signal of the second wavelength group are cores adjacent to each other.

5. The optical transmission system according to claim 1, wherein
the first multi-core fiber includes a first core that transmits an optical signal of the first wavelength group and a second core that transmits an optical signal of the second wavelength group,
the second multi-core fiber includes a third core that transmits an optical signal of the first wavelength group and a fourth core that transmits an optical signal of the second wavelength group, and
the optical relay apparatus includes:
a first converter that couples the optical signal of the first wavelength group transmitted through the first core and the optical signal of the second wavelength group transmitted through the second core to generate a first coupled optical signal;
an amplifier that amplifies the first coupled optical signal generated; and
a second converter that splits the first coupled optical signal amplified into an optical signal of the first wavelength group and an optical signal of the second wavelength group, outputs the optical signal split of the first wavelength group to the third core, and outputs the optical signal split of the second wavelength group to the fourth core.

6. The optical transmission system according to claim 5, wherein the optical relay apparatus includes a gain flattening filter that performs gain flattening on the first coupled optical signal amplified.

7. The optical transmission system according to claim 6, wherein the gain flattening filter performs gain flattening on the optical signal of the first wavelength group included in the first coupled optical signal amplified and performs gain flattening on the optical signal of the second wavelength group included in the first coupled optical signal amplified.

8. The optical transmission system according to claim 6, wherein the gain flattening filter includes a first gain flattening filter that performs gain flattening on the optical signal of the first wavelength group included in the first coupled optical signal amplified, and a second gain flattening filter that performs gain flattening on the optical signal of the second wavelength group included in the first coupled optical signal amplified.

9. The optical transmission system according to claim 5, wherein
the amplifier includes a first amplification core that amplifies the coupled first coupled optical signal,
the first converter converts an optical signal of the first wavelength group from the first core and an optical signal of the second wavelength group from the second core into the first coupled optical signal to be output to the first amplification core, and
the second converter converts the first coupled optical signal from the first amplification core into an optical signal of the first wavelength group to be output to the third core and an optical signal of the second wavelength group to be output to the fourth core.

10. The optical transmission system according to claim 5, wherein
the first multi-core fiber includes a fifth core that transmits the optical signal of the first wavelength group and a sixth core that transmits the optical signal of the second wavelength group,
the second multi-core fiber includes a seventh core that transmits the optical signal of the first wavelength group and an eighth core that transmits the optical signal of the second wavelength group,
the first converter couples the optical signal of the first wavelength group transmitted through the fifth core and the optical signal of the second wavelength group transmitted through the sixth core to generate a second coupled optical signal,
the amplifier amplifies the second coupled optical signal generated, and
the second converter splits the second coupled optical signal amplified into an optical signal of the first wavelength group and an optical signal of the second wavelength group, outputs the optical signal split of the first wavelength group to the seventh core, and outputs the optical signal split of the second wavelength group to the eighth core.

11. The optical transmission system according to claim 5, wherein
the first multi-core fiber includes a fifth core that transmits the optical signal of the first wavelength group and a sixth core that transmits the optical signal of the second wavelength group,
the second multi-core fiber includes a seventh core that transmits the optical signal of the first wavelength group and an eighth core that transmits the optical signal of the second wavelength group,
the second converter couples the optical signal of the first wavelength group transmitted through the seventh core and the optical signal of the second wavelength group transmitted through the eighth core to generate a third coupled optical signal,
the amplifier amplifies the third coupled optical signal generated, and
the first converter splits the third coupled optical signal amplified into an optical signal of the first wavelength group and an optical signal of the second wavelength group, outputs the optical signal split of the first wavelength group to the fifth core, and outputs the optical signal split of the second wavelength group to the sixth core.

12. The optical transmission system according to claim 1, wherein
the first multi-core fiber transmits an optical signal of a third wavelength group including a plurality of consecutive wavelengths different from the first and second wavelength groups and an optical signal of a fourth wavelength group including a plurality of consecutive wavelengths different from the first to third wavelength groups by further different cores,
the second multi-core fiber transmits the optical signal of the third wavelength group and the optical signal of the fourth wavelength group by further different cores, and
the optical relay apparatus amplifies an optical signal obtained by coupling the optical signal of the third wavelength group and the optical signal of the fourth wavelength group transmitted via each core of the first multi-core fiber, and outputs the optical signal of the third wavelength group and the optical signal of the fourth wavelength group split from the optical signal amplified to each core of the second multi-core fiber.

13. An optical relay apparatus comprising:
a first converter that couples an optical signal of a first wavelength group including a plurality of consecutive wavelengths and an optical signal of a second wavelength group including a plurality of consecutive wavelengths different from the first wavelength group transmitted through different cores of a first multi-core fiber;
an amplifier that amplifies the optical signal coupled; and
a second converter that splits the optical signal amplified into an optical signal of the first wavelength group and an optical signal of the second wavelength group, and outputs the optical signal split of the first wavelength group and optical signal of the second wavelength group to different cores of a second multi-core fiber.

14. An optical transmission method comprising:
transmitting, in a first multi-core fiber, an optical signal of a first wavelength group including a plurality of consecutive wavelengths and an optical signal of a second wavelength group including a plurality of consecutive wavelengths different from the first wavelength group by different cores;
transmitting the optical signal of the first wavelength group and the optical signal of the second wavelength group by different cores in a second multi-core fiber; and
amplifying, in an optical relay apparatus, an optical signal obtained by coupling the optical signal of the first wavelength group and the optical signal of the second wavelength group transmitted via each core of the first multi-core fiber, and outputting the optical signal of the first wavelength group and the optical signal of the second wavelength group split from the optical signal amplified to each core of the second multi-core fiber.
